(19) United States
(12) Patent Application Publication
(10) Pub. No.: US 2014/0231113 A1
(43) Pub. Date: Aug. 21, 2014

(54) HAND-HELD POWER TOOL AND METHOD FOR OPERATING THE HAND-HELD POWER TOOL

(71) Applicant: Christoph STEURER, Urbach (DE)

(72) Inventor: Christoph STEURER, Urbach (DE)

(73) Assignee: ROBERT BOSCH GMBH, Stuttgart (DE)

(21) Appl. No.: 14/186,493

(22) Filed: Feb. 21, 2014

(30) Foreign Application Priority Data
Feb. 21, 2013 (DE) 10 2013 202 832.6

(51) Int. Cl. B23Q 11/00; B25F 5/02

(52) U.S. Cl. CPC B23Q 11/0078; B25F 5/02
USPC 173/1; 173/2

(57) ABSTRACT

A method is provided for controlling an electric hand-held power tool having a device housing and a coupling device on the device housing side for securing an auxiliary handle to the device housing. It is detected whether the auxiliary handle is secured to the device housing and/or whether the auxiliary handle is gripped by a user. In addition, the instantaneous operating state is ascertained and evaluated. A protective function is activated when the occurrence of a critical operating case is recognized during the evaluation of the instantaneous operating state. It is provided that the evaluation of the instantaneous operating state and/or the activation of the protective function is/are carried out as a function of whether the auxiliary handle is secured to the device housing and/or whether the auxiliary handle is gripped by the user.

### FIELD OF THE INVENTION

The present invention relates to a hand-held power tool having an auxiliary handle, and a method for operating the hand-held power tool.

### BACKGROUND INFORMATION

Hand-held power tools in various variants are known from the related art. In particular high-power hand-held power tools such as cordless screwdrivers, percussion drills, or percussion hammers, for example, typically have an auxiliary handle which allows safe handling using the particular electric tool. These auxiliary handles are typically removably mounted on the housing of the particular hand-held power tool with the aid of a special fastener. Due to the high torque which such a tool may generate during operation, use of the tool without an appropriate auxiliary handle represents a relatively high safety risk for the particular user. Thus, very high torque peaks may occur in drills, screwdrivers, or similar rotating machine tools in certain operating states, which may result in undesirable twisting of the hand of the user holding the tool.

### SUMMARY

It is an object of the present invention, therefore, to increase the operational safety of machine tools having mountable auxiliary handles. This object is achieved by a method, and by an electric hand-held power tool.

According to the present invention, a method for controlling an electric hand-held power tool having a housing and a coupling device on the housing side for securing an auxiliary handle to the housing is provided, it being detected whether an auxiliary handle is secured to the housing, and/or whether the auxiliary handle is gripped by a user. In the method, the instantaneous operating state is also ascertained and evaluated, a protective function being activated when the occurrence of a critical operating case is recognized during the evaluation of the instantaneous operating state. It is provided that the evaluation of the instantaneous operating state and/or the activation of the protective function is/are carried out as a function of whether the auxiliary handle is secured to the housing and/or whether the auxiliary handle is gripped by a user. The use of the protective function may thus be optimally adapted to the requirements of the particular configuration. In particular, the situation may thus be effectively avoided that if an auxiliary handle is not present on the housing or in the case that the auxiliary handle is not gripped or is not correctly gripped by the user, the operation of the machine tool results in an injury to the particular user.

In one specific embodiment it is provided that a certain evaluation algorithm is used for evaluating the instantaneous operating state, the evaluation algorithm being adapted as a function of the result of the detection of the auxiliary handle and/or of the result of the detection of the gripping of the auxiliary handle by the user. It is thus possible to use in each case an evaluation algorithm which is optimally adapted to the instantaneous configuration for recognizing critical operating cases.

Another specific embodiment provides that in the evaluation of the instantaneous operating state, a check is made as to whether a certain parameter of the machine tool is above or below a predefined threshold value. The threshold value is adapted as a function of the result of the detection of the auxiliary handle and/or as a function of the result of the detection of the gripping of the auxiliary handle by the user. The adaptation of the threshold value represents a particularly simple option for optimizing the system response for various configurations or operating modes.

In another specific embodiment it is provided that the evaluation of the instantaneous operating state and/or the activation of the protective function is/are suppressed if it is detected that the auxiliary handle is secured to the housing and/or is gripped by the user. It can thus be assured that the protective function is activated or is used in particular when the user is not holding the machine tool with both hands. In particular for less high-power machine tools, the situation may thus be prevented that unnecessary or undesirable activation of the protective function takes place when the machine tool is being safely handled.

Another specific embodiment provides that a kickback event caused by jamming of an insertion tool rotationally driven by the machine tool is recognized as a critical operating case, the activation of the protective function causing a reduction in the power consumption or complete switching off of the drive motor. In particular for high-power machine tools or at high rotational speeds, such kickback events may result in hazardous torque peaks. Injuries to the user may be avoided by reducing the power consumption or by completely switching off the drive motor when kickback events occur.

According to the present invention, a machine tool having a housing, a coupling device on the housing side for securing an auxiliary handle to the housing, and a detection device for detecting the auxiliary handle on the housing and/or the gripping of the auxiliary handle, secured to the housing, by a user is also provided. The machine tool also includes a drive motor and a control device for controlling the drive motor, having an evaluation circuit for evaluating the instantaneous operating state of the electric machine tool. The control device is designed to activate a protective function when the evaluation device recognizes the occurrence of a critical operating case. The control device is also designed to carry out the evaluation of the instantaneous operating state and/or the activation of the protective function as a function of the detection of the auxiliary handle on the housing and/or the gripping of the auxiliary handle by the user. With the aid of the special detection device, the control device may recognize the various configurations of the machine tools and appropriately carry out the evaluation of the instantaneous operating state or the activation of the protective function, in each case as a function of the detection result.

One specific embodiment provides that the evaluation device uses a certain evaluation algorithm for evaluating the instantaneous operating state, the control device being designed to adapt the evaluation algorithm as a function of the result of the detection of the auxiliary handle and/or the gripping of the auxiliary handle by the user. For this purpose, multiple different evaluation algorithms are preferably implemented in the control device which in each case allow an optimal evaluation of the operating state in the various configurations of the machine tools.

Another specific embodiment provides that a kickback sensor device is provided for detecting a kickback event caused by jamming of an insertion tool rotationally driven by the electric machine tool. The control device is designed to reduce the power of the drive motor or to completely switch off the drive motor in the event of a recognized kickback event. With the aid of suitable kickback sensor devices, the kickback events, which are hazardous for the user, may be reliably recognized and the power of the drive motor may be reduced as a response to same.

In another specific embodiment, it is provided that the detection device includes a detector unit which is situated in the area of the coupling device on the housing side and which electrically, magnetically, optically, and/or mechanically detects the presence of the auxiliary handle. In another specific embodiment, it is also provided that the detection device includes a sensor unit, situated in the auxiliary handle, which electrically, magnetically, optically, and/or mechanically detects the gripping of the auxiliary handle by the user. The various configurations of the machine tool may be reliably differentiated with the aid of the detection device and the corresponding sensor unit.

### BRIEF DESCRIPTION OF THE DRAWINGS

FIG. 1 schematically illustrates an electric machine tool according to the present invention, having a detection device which includes a configuration detector for the auxiliary handle and a grip detector for detecting the gripping of the auxiliary handle by a user.

FIG. 2 shows one alternative specific embodiment of the electric machine tool, having a detection circuit which is situated separately from the control device.

FIG. 3 shows a detailed illustration of the detection device from FIG. 1, having a configuration detector which includes a Hall sensor.

FIG. 4 shows one alternative specific embodiment of the machine tool, having a configuration detector implemented in the form of electrical contacts.

FIG. 5 shows another alternative specific embodiment of the machine tool, having a configuration detector and a grip detector which are combined via circuitry.

### DETAILED DESCRIPTION

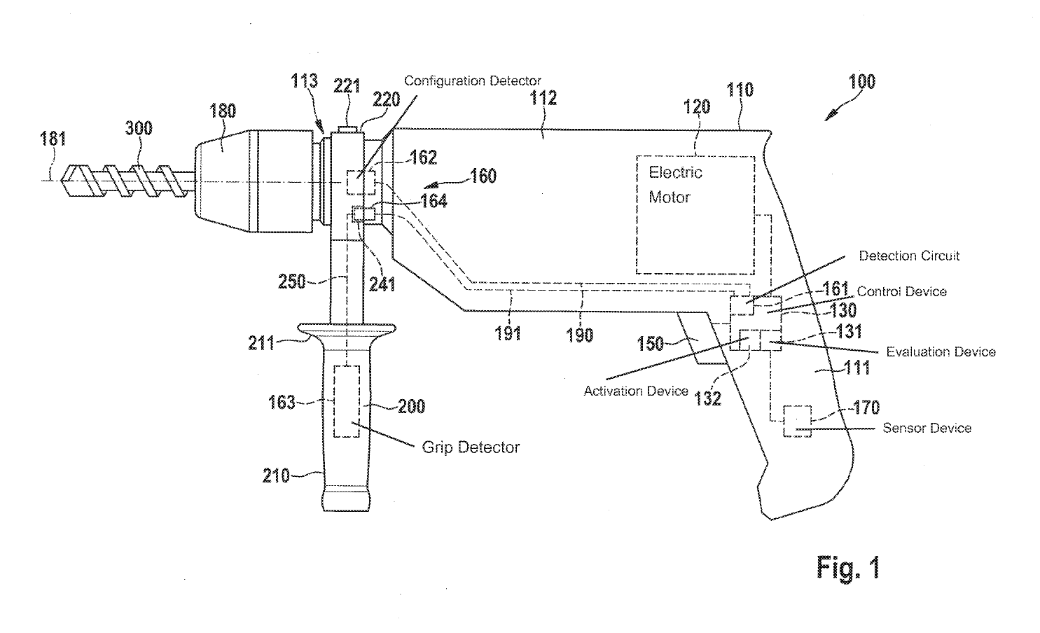

FIG. 1 shows a schematic illustration of an electric hand-held power tool 100 which is designed, for example, in the form of a drill, hammer drill, power screwdriver, or a similar device. Machine tool 100 has a pistol-like device housing 110, typical of such drill-like devices, having a rear housing part 111 which forms a handle, a vertical central housing part 112 connected to the rear housing part, and a front housing part 113 connected to the central housing part. Front housing part 113 is typically designed in the form of a machine neck for accommodating an auxiliary handle 200. Auxiliary handle 200 is generally secured to front housing part 113 via a releasable clamp connection. For this purpose, a coupling device 220 of auxiliary handle 200, typically designed as a clamping ring, is mounted on front housing part 113 and fixed with the aid of a clamping screw 221.

A holding device 180 for holding an insertion tool 300 which rotates about a rotating axis 181 is also situated on front housing part 113. This holding device 180, which is typically designed in the form of a drill chuck, is rotationally driven about predefined rotational axis 181 by an electric drive motor 120 accommodated in central housing part 112. A suitable gear (not shown here) may be connected between holding device 180 and drive motor 120.

Electric hand-held power tool 100 also includes a control device 130 for controlling electric motor 120. Control device 130 determines the torque provided by drive motor 120 as a function of the particular operating mode. At least one control element 140, which is connected to control device 130, is situated on device housing 110 for selecting an operating mode. For the sake of clarity, only one main switch 140 is illustrated in the exemplary embodiment shown here.

Electric hand-held power tool 100 may be equipped with one or multiple sensors for monitoring the instantaneous operating state. For example, microelectromechanical initial sensors which detect the movements of the machine tool in one or multiple spatial directions or spatial axes are used as sensors. Hand-held power tool 100 according to the present invention includes a sensor device 170 having one or multiple such initial sensors (not shown here). Sensor device 170, which is accommodated, for example, in handle part 111 of housing 110, represents part of a higher-order safety device for activating a protective function when critical operating states of the machine tool occur. In the present example, the safety device is designed for recognizing kickback events which may occur during operation of machine tool 100 due to jamming of insertion tool 300 in a workpiece. For this purpose, sensor device 170 suitably detects the rotational motion or rotational acceleration of machine tool 100 about rotational axis 181. An evaluation device 131 which is preferably provided within control device 130 evaluates the operating state of machine tool 100 according to predefined criteria, based on the signal of sensor device 170, and registers the occurrence of critical operating cases. If such a critical operating case, for example a kickback event, is recognized, activation device 132 provided within control device 130 activates an appropriate safety function. In the case of a kickback event, the activation of the safety function results in a reduction in the power of the drive motor or complete switching off of the drive motor. Depending on the application, a forced braking system may also be used to bring the motor to a standstill as quickly as possible. The criteria according to which a certain operating situation is assessed as a critical operating case and the safety function is thereupon activated may vary, depending on the operating mode or type of operation. In addition, the system response to the detection of a critical operating situation may be selected as a function of the particular operating mode or the particular type of operation. According to the present invention, the configuration of machine tool 100 is used to differentiate between various operating modes or types of operation. In this regard, a distinction is made as to whether the machine tool is equipped with an auxiliary handle 200 and whether this auxiliary handle 200 is also appropriately gripped by the user. Depending on the recognized configuration, various allowable torques due to critical events such as the kickback event result which are permitted on the machine. For checking the corresponding configuration, machine tool 100 is equipped with a special detection device 160. Detection device 160 includes a configuration detector 162 for detecting the auxiliary handle, and/or a grip detector 163, accommodated in auxiliary handle 200, for detecting the gripping of auxiliary handle 200 by the user. In principle, various detection or measuring methods may be used for implementing configuration detector 162. Thus, configuration detector 162 may, for example, magnetically, electrically, optically, or mechanically detect the presence of auxiliary handle 200.

In principle, grip detector 163 may also use various detection and measuring methods to detect grasping or gripping of the auxiliary handle by the user. For this purpose, grip detector 163 may detect one or multiple physical variables which experience a change caused by the hand of the particular user gripping auxiliary handle 200. Thus, for example, the gripping of auxiliary handle 200 may be magnetically detected based on a change in the magnetic properties inside the auxiliary handle caused by the hand of the user. Similarly, a change in an electrical field generated by grip detector 163 in the area of auxiliary handle 200 due to the gripping of auxiliary handle 200 may be used for detecting the gripping of auxiliary handle 200. For this purpose, for example, grip detector 163 may be designed in the form of a capacitive detector situated in the gripping surface of the auxiliary handle.

The two detectors 162, 163 are preferably connected to a shared detection circuit 161 which evaluates the signals of the two detectors 162, 163 and provides the corresponding detection results to control device 130. Detection circuit 161 may be situated within control device 130, as is the case in the present exemplary embodiment. For supplying power to the two detectors 162, 163 and for receiving the corresponding detector signals, the two detectors 162, 163 are connected to detection circuit 161 via electrical lines 190, 191. Electrical connecting lines 190, 191 illustrated in the figures may be individual lines or also a bundle of lines extending in parallel, depending on the application. Depending on the application, both detectors 162, 163 may be connected to evaluation circuit 161 via shared or separate electrical lines.

Depending on whether auxiliary handle 200 is mounted, and whether the auxiliary handle is gripped by the user, detection circuit 161 provides control device 130 with the detection result in the form of suitable information. With the aid of the detection result, control device 130 adapts the evaluation of evaluation device 131 and/or the response of activation device 132 to the particular configuration or to the particular operating conditions. In this regard, in particular the selected algorithm of evaluation device 131 may be changed as a function of whether auxiliary handle 200 is connected, and whether auxiliary handle 200 is also correctly gripped by the particular user. In the simplest case, only the threshold values of the variable detected by sensor device 170 are varied corresponding to the detection result. For the kickback recognition, for example the rotational acceleration threshold value above which a rotational acceleration detected by sensor device 170 is assessed as critical and results in an activation of the kickback protective function, may be set relatively high for an auxiliary handle 200 which is mounted and gripped by the user, whereas in the case that no auxiliary handle 200 is detected, this threshold value may be set relatively low. For the case that auxiliary handle 200 is mounted, but is not gripped or is not correctly gripped by the user, an average threshold value, for example, may be used. It may thus be taken into account that the user is still able to grip auxiliary handle 200 in a timely manner as a response to a deflection of machine tool 100, and is thus able to absorb the deflection in a timely manner with both hands.

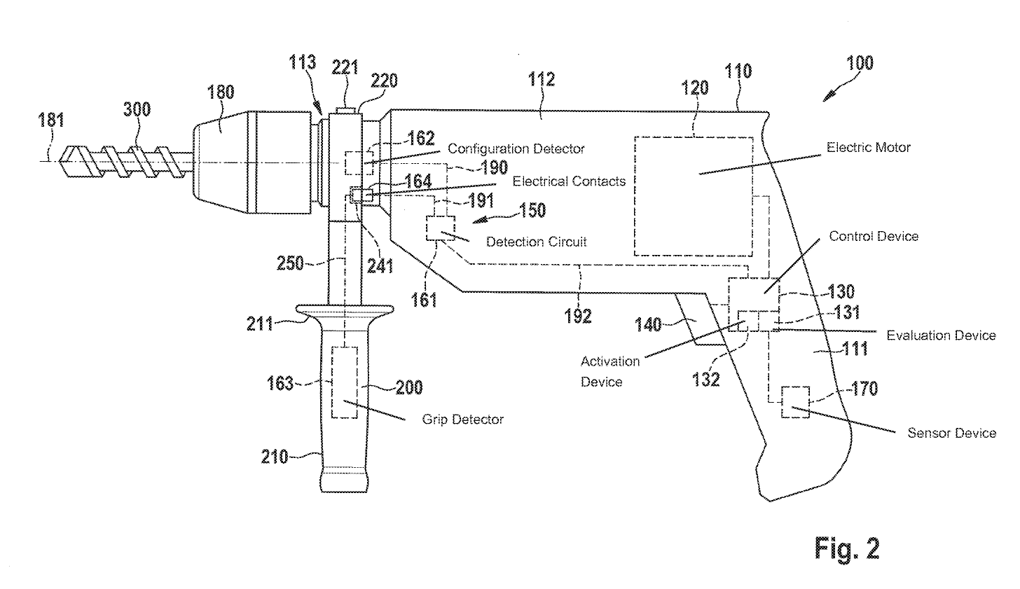

To reduce the outlay for cabling of the two detectors 162, 163, detection circuit 161 may also be situated separately from control device 130 in a front area of device housing 110. FIG. 2 shows an alternative specific embodiment of the machine tool having an appropriately separately situated detection circuit 161. Detection circuit 161 is now connected to control device 130 via an independent connecting line or connecting lines 192.

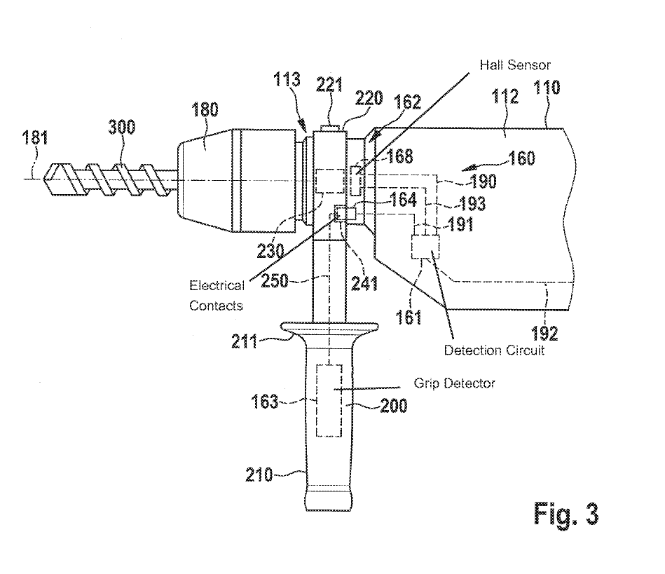

In principle, the detection of auxiliary handle 200 may be carried out in any suitable manner. In particular, configuration detector 162 may be designed in the form of a measuring device for measuring a physical variable which is influenceable by auxiliary handle 200. FIG. 3, for example, shows one possible embodiment of configuration detector 162 in which auxiliary handle 200 is magnetically detected. For this purpose, a Hall sensor 168 is situated in the front area of device housing 110, and is connected to detection circuit 161 via electrical connecting lines 190, 193 for supplying power and detecting the measuring signal. In the mounted state of auxiliary handle 200, a magnet 167 situated in auxiliary handle 200 generates a suitable magnetic field, which is detected by Hall sensor 168 and is measurable in detection circuit 161 as a corresponding sensor signal. For this purpose, magnet 167 is preferably situated in clamping ring 220 of auxiliary handle 200 in such a way that in the mounted state of auxiliary handle 200 the magnetic field of the magnet is sufficiently well readable by Hall sensor 168. To implement multiple mounting positions of the auxiliary handle, multiple such magnets (not shown here) may also be situated along the periphery of clamping ring 220.

In addition to a magnetic detection of auxiliary handle 200, in principle electrostatic or electromagnetic interactions between auxiliary handle 200 and device housing 110 may also be used for detecting the presence or the correct mounting of auxiliary handle 200. Optical detection of auxiliary handle 200 is also possible in principle, for example in the form of a photoelectric barrier which is situated in device housing 110 and is interrupted by mounted auxiliary handle 200. In addition, purely mechanical detection of auxiliary handle 200 may take place.

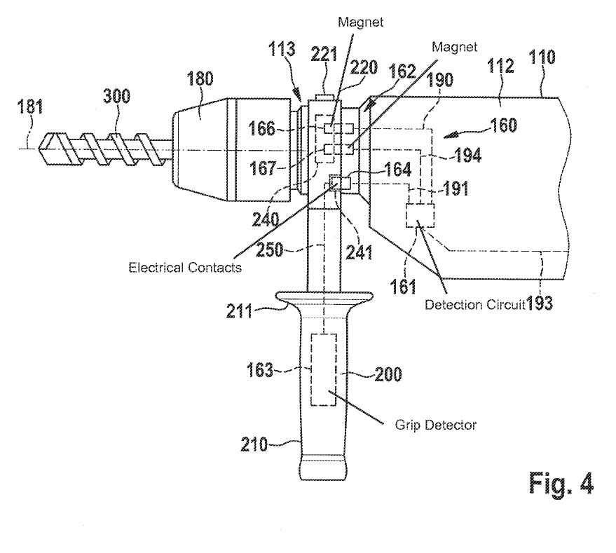

Furthermore, auxiliary handle 200 may be detected, for example, with the aid of an electrical switch accommodated in device housing 110, the switching state of the electrical switch being changed by the mounting of auxiliary handle 200. In the simplest case, such an electrical switch may be designed in the form of simple contacts which generate a closed circuit due to the mounting of auxiliary handle 200. In this regard, FIG. 4 shows a corresponding embodiment of configuration detector 162, which includes two contacts situated in the area of machine neck 113 on the exterior of housing 110 and a short circuit element 240 situated on clamping ring 220 of auxiliary handle 200. Short circuit element 240 is designed in the form of an electrical bridge which in the mounted state of auxiliary handle 200 electrically connects the two electrical contacts 166, 167 on the housing side to one another. In the event of a short circuit between the two lines 190, 194, detection circuit 161 registers correctly mounted auxiliary handle 200 and relays a corresponding signal to control device 130. To enable various allowed mounting positions of auxiliary handle 200 on device housing 110, multiple such short circuit elements may also be distributed along the periphery of clamping ring 220. Alternatively, a ring-shaped short circuit element appropriately situated in the peripheral direction may be used which allows an electrical connection between the two contacts 166, 167 in various mounting positions of auxiliary handle 200 on device housing 110. As an alternative to a short circuit element 240, an electrical bridge having a defined ohmic resistance which is readable by detection circuit 161 may be provided which even allows a differentiation between various auxiliary handles and clamping devices for machine tool 100.

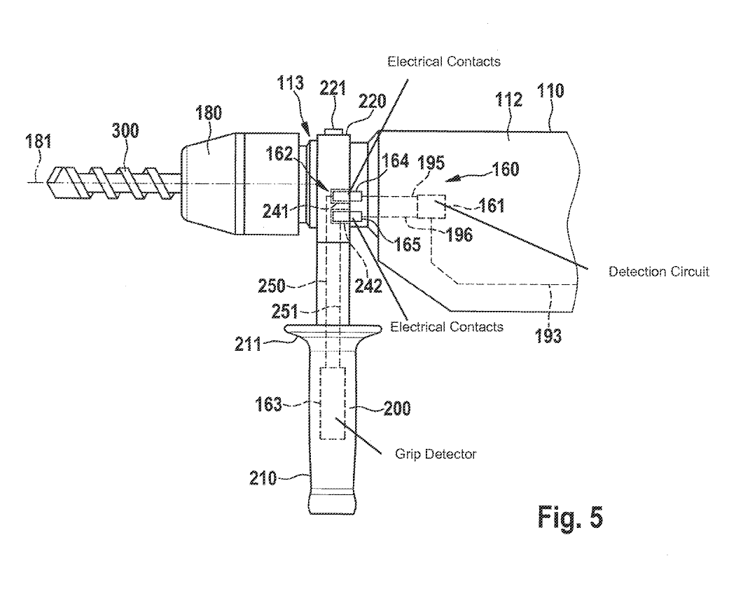

To reduce the complexity of circuitry, the functions of configuration detector 162 and of grip detector 163 may also be combined via circuitry. In this regard, FIG. 5 shows an example of a detection device 160 in which configuration detector 162 is implemented solely with the aid of electrical contacts 164, 165, 241, 242. When auxiliary handle 200 is correctly mounted on machine housing 110, grip detector 163 is electrically connected to detection circuit 161 via electrical conductor structures 195, 164, 241, 250 and 196, 165, 242, 251. It is thus possible for detection circuit 161 to detect the presence of grip detector 163 and thus also to detect mounted auxiliary handle 200. This may be carried out, for example, by evaluating the voltage signal between the two lines 195, 196.

The specific embodiments explained with reference to the figures merely represent preferred or exemplary embodiments of the present invention. In addition to the described and illustrated specific embodiments, other specific embodiments are conceivable which may include further modifications as well as combinations of features. In addition to the rotational acceleration, deflection, or rotational rate mentioned here, in principle any suitable measurable variable with the aid of which critical operating states may be recognized are appropriate parameters for describing the operating state of the machine tool. In this regard, these also include, for example, electrical measured variables such as the current intensity and the voltage of electric motor 120, on the basis of which sudden load fluctuations may be well detected. In addition, a combination of various measured variables as well as their development over time may be used for monitoring the operating state of the machine tool.

What is claimed is:

1. A method for controlling an electric hand-held power tool having a device housing and a coupling device on a housing side for securing an auxiliary handle to the device housing, comprising:
detecting at least one of whether the auxiliary handle is secured to the device housing and whether the auxiliary handle is gripped by a user;
ascertaining and evaluating an instantaneous operating state; and
activating a protective function when an occurrence of a critical operating case is recognized during the evaluation of the instantaneous operating state, wherein at least one of the evaluation of the instantaneous operating state and the activation of the protective function is carried out as a function of at least one of whether the auxiliary handle is secured to the device housing and whether the auxiliary handle is gripped by the user.

2. The method as recited in claim 1, wherein the evaluating of the instantaneous operating state includes performing a certain evaluation algorithm that is adapted as a function of a result of at least one of the detection of the auxiliary handle and the detection of the gripping of the auxiliary handle by the user.

3. The method as recited in claim 1, wherein in the evaluation of the instantaneous operating state, a check is made as to whether a certain parameter of the hand-held power tool is above or below a predefined threshold value, the threshold value being adapted as a function of the result of at least one of the detection of the auxiliary handle and the detection of the gripping of the auxiliary handle by the user.

4. The method as recited in claim 1, further comprising:
suppressing at least one of the evaluation of the instantaneous operating state and the activation of the protective function if at least one of the auxiliary handle is detected as secured to the housing and the auxiliary handle is detected as gripped by the user.

5. The method as recited in claim 1, further comprising:
recognizing as a critical operating case a kickback event caused by a jamming of an insertion tool rotationally driven by the hand-held power tool, wherein the activation of the protective function causes one of a reduction in a power consumption of a drive motor and a complete switching off of the drive motor.

6. An electric hand-held power tool, comprising:
a device housing;
a coupling device on the device housing side for securing an auxiliary handle to the device housing;
a detection device for detecting at least one of the auxiliary handle on the device housing and a gripping of the auxiliary handle, secured to the device housing, by a user;
an electric drive motor;
a control device for controlling the drive motor and having an evaluation device for evaluating an instantaneous operating state of the electric hand-held power tool; and
an activation device for activating a protective function when the evaluation device recognizes an occurrence of a critical operating case, wherein:
the control device performs at least one of the evaluation of the instantaneous operating state and the activation of the protective function as a function of the detection of at least one of the auxiliary handle on the device housing and the gripping of the auxiliary handle by the user.

7. The electric hand-held power tool as recited in claim 6, wherein the evaluation device performs a certain evaluation algorithm for evaluating the instantaneous operating state, the control device adapting the evaluation algorithm as a function of a result of the detection of at least one of the auxiliary handle and the gripping of the auxiliary handle by the user.

8. The electric hand-held power tool as recited in claim 6, further comprising:
a kickback sensor device, wherein the evaluation device evaluates a signal of the kickback sensor device, and recognizes as the critical operating case a kickback event caused by a jamming of an insertion tool which is rotationally driven by the electric hand-held power tool, and wherein the activation device one of reduces a power consumption of the drive motor and completely switches off the drive motor in the event of a recognized kickback event.

9. The electric hand-held power tool as recited in claim 6, wherein the detection device includes a configuration detector, situated in an area of the coupling device on a device housing side, for detecting the auxiliary handle, the configuration detector performing at least one of an electrical, magnetic, optical, and mechanical detection of the auxiliary handle.

10. The electric hand-held power tool as recited in claim 6, wherein the detection device includes a grip detector situated in the auxiliary handle, the grip detector performing at least one of an electrical, magnetic, optical, and mechanical detection of the gripping of the auxiliary handle by the user.
